(19) United States
(12) Patent Application Publication
(10) Pub. No.: US 2008/0093963 A1
(43) Pub. Date: Apr. 24, 2008

(54) Lamp

(75) Inventors: Leo Gustaaf Joanna Emiel Marien, Turnhout (BE); Paulus Albertus Maria Vermeulen, Turnhout (BE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/573,899

(22) PCT Filed: Aug. 10, 2005
(86) PCT No.: PCT/IB05/52661

§ 371 Date: Feb. 19, 2007

(30) Foreign Application Priority Data
Aug. 23, 2004 (EP) 04104038.7

(51) Int. Cl. H01J 5/16; H01J 17/16

(52) U.S. Cl. 313/113; 313/636; 313/634

(57) ABSTRACT

The invention relates to lamp comprising a light source in an outer envelope which is connected to a lamp base in a gas-tight manner. According to the invention, the lamp base is substantially made of a metal.

The invention relates to a lamp comprising a light-emitting object in an outer envelope which is connected to a lamp base in a gas-tight manner. In particular, the invention relates to a high-pressure discharge lamp.

Such a lamp is known from DE 3028405 which describes a discharge lamp with an outer envelope of glass connected to the lamp base in a gas-tight manner. The lamp base described in DE 3028405 is a glass plate which is connected to the outer envelope by means of a melting process. The glass plate of the known lamp is provided with pins serving as contact members. The known lamp has a relatively simple construction, which allows a simplified industrial production.

The known lamp has the drawback that a connection between the glass plate lamp base and the glass envelope made by means of a melting process causes stresses in the glass, which shorten the service life of the lamp and particularly of a high-pressure discharge lamp subjected to significant temperature cycles. Stresses in the glass may produce cracks, through which oxygen can penetrate the outer envelope. They also increase the sensitivity of the lamp to fracture due to mechanical shock or vibrations.

It is an object of the invention to eliminate or at least mitigate the above drawback.

According to the invention, a lamp of the type mentioned in the opening paragraph comprises a lamp base which is substantially made of a metal.

The lamp according to the invention ensures a better resistance against cracking and leakage of the outer envelope, while it maintains its relatively simple construction allowing a simplified industrial assembly.

The lamp according to the invention has the additional advantage that the metal base serves as an interface between the light-emitting object and the lamp holder. A lamp holder may be a socket or an integrated circuit board.

The lamp according to the invention has the further advantage that the metal base serves as a heat sink, which allows a size reduction of the lamp. The metal base may also comprise a lamp identification, thus avoiding the need of a separate identification step in the production process of the lamp according to the invention.

The lamp base in the lamp according to the invention is substantially made of a metal. In this description, “substantially made of a metal” is understood to mean that the metal base may comprise non-metal parts, for example, for insulating a connection member from the metal base. Suitable metals for the lamp base are those metals having a coefficient of thermal expansion (CTE) that approximates the CTE of the material of the outer envelope.

A preferred embodiment of the lamp according to the invention is characterized in that the outer envelope is connected in a gas-tight manner to the metal lamp base by means of an enamel. In the art, an enamel is also known as a frit, a sealing frit, a sealing glass, or a sealing ceramic. The enamel is preferably provided in the form of a pre-shaped ring. The use of a pre-shaped ring significantly simplifies the manufacture of the high-pressure discharge lamp. Typically, the outer envelope is fastened to the metal base with an enamel by melting the enamel ring at a temperature below 600° C. The fact that the outer envelope does not melt at this temperature contributes to a precise positioning of the outer envelope with respect to the metal base and prevents stresses building up in the outer envelope. The enamel ring can be heated via the metal base, which in turn can be heated e.g. by a high-frequency generator or an infrared heat source.

The composition of the enamel is chosen to be such that the CTE of the enamel is close to or in between the CTE of the envelope and the CTE of the metal base. In order to match the CTE of the metal base with the CTE of the envelope, the base is preferably made of a FeNiCo alloy.

When the outer envelope has about the same CTE as the metal base, the connection between the outer envelope and the base can be made by directly melting the outer envelope onto the lamp base. A direct melt connection can be formed by raising the temperature in the sealing area, while pressing the outer envelope against the metal base.

In this way, the glass is homogeneously heated, thus avoiding the development of internal stresses in the glass envelope.

Another advantage of the lamp according to the invention is its higher mechanical resistance against fracture as compared with a lamp having a pinch-sealed base.

The lamp according to the invention comprises an electric light source. An electric light source may be an incandescent filament, a discharge vessel or a LED. The lamp according to the invention is preferably a high-pressure discharge lamp comprising a discharge vessel (burner) provided with an ionizable filling. A high-pressure discharge lamp either has a burner with a ceramic wall or a burner made of quartz or of quartz glass. Such high-pressure discharge lamps are widely used in a large range of different applications and combine a high luminous efficacy with favorable color properties. In this description and claims, the ceramic wall of a discharge vessel is understood to be a wall made of one of the following materials: mono-crystalline metal oxide (for example, sapphire), translucent densely sintered polycrystalline metal oxide (for example, Al₂O₃, YAG), and translucent densely sintered polycrystalline metal nitride (for example, AlN). Quartz and quartz glass are understood to be glass having a SiO₂ content of at least 95%.

The outer envelope of the lamp according to the present invention may be soft glass, hard glass, quartz glass, quartz or a ceramic material as described above.

A light source generally comprises two current supply conductors. The lamp base is preferably a first contact member which is connected to a first current-supply conductor. An advantage of a base as contact member for the pins used in the known lamp is that the length of the lamp is significantly reduced and consequently contributes to a further size reduction of the lamp according to the invention.

A second contact member can be provided in the lamp base. In that case, the second contact member is insulated from the lamp base. The second contact member is preferably placed at the center of the lamp base and connected to a second current-supply conductor. The first and the second contact member preferably provide the mechanical support of the discharge vessel connection and the electric contact between the electrodes in. the discharge vessel and the exterior of the high-pressure discharge lamp.

An advantage of a second contact member positioned at the center of the lamp base is that it facilitates the use of the base plate center as a positioning point of reference for placing the burner at the center of the lamp with a high dimensional accuracy, which is beneficial for achieving a homogeneous temperature along the circumference of the lamp's outer envelope as well as a substantial isotropic light distribution. A burner which is placed in the center of the lamp with a high dimensional accuracy is particularly advantageous when the lamp is placed in a reflector and whose light beam should be as homogeneous as possible.

The outer envelope is connected to the lamp base in a gas-tight manner. Controlling the atmosphere in the outer envelope provides the possibility of protecting the current-supply conductors against oxidation. The phrase “controlling the atmosphere in the outer envelope” is understood to mean evacuating the outer envelope or filling with a defined gas environment, which in particular is free from oxidizing agents, like oxygen.

A preferred embodiment of the lamp according to the invention is characterized in that an exhaust for evacuating the outer envelope is provided in the lamp base. This has the advantage that the outer envelope can be evacuated via the exhaust after the light source (for instance, a discharge vessel) and the outer envelope have been mounted on the lamp base of the lamp. This exhaust can be managed with a hole or a tube in the base, which can easily be closed by welding after the outer envelope has been evacuated or filled with a gas. In a further preferred embodiment, a (e.g. second) contact member is used as exhaust. Then the contact member may consist of a tube through which the outer envelope can be evacuated. This has the advantage of a further simplified lamp construction.

A getter is preferably used inside the outer envelope so as to absorb impurities, for instance, a mix of water, hydrogen, oxygen or hydrocarbons. In the lamp according to the invention, the getter can be placed close to the metal base. An advantage of a getter thus placed is that it does not interfere with the light beam of the light-emitting object. Particularly in a reflector, this does not only result in a higher light output of the lamp, but also protects the getter against excessive heating by reflected light and infrared (ir)radiation generated by the light source. A getter is generally placed on the other side of the light-emitting object in order to avoid poisoning of the getter by the temperatures which are required to form the connection between the outer envelope and the base. An advantage of the metal base in the lamp according to the invention is that it allows the lamp to be sealed quickly and at a relatively low temperature, thus avoiding poisoning of a getter placed close to the lamp base.

A preferred embodiment of the lamp according to the invention comprises an assembly of a light source in an outer envelope, the outer envelope being a parabolic reflector. An advantage of the lamp with a parabolic reflector as an outer envelope is found in its production process. Known reflectors are built onto the lamp holder, with a first current supply through the base and a second current supply, which had to be connected to an external contact point as described in e.g. U.S. Patent 2003/0001502. After the connection is made, a lens or front glass is sealed onto the parabolic reflector in a gas-tight manner. The production process of the lamp according to the invention has the advantage that an integrated envelope of reflector and lens or front glass can be connected to the lamp base in a gas-tight manner, after which the reflector can be evacuated and/or filled with a suitable gas.

An advantage of the lamp according to the invention is the accurate positioning of the light-emitting object in the focus of the reflector by mounting the light-emitting emitting object on a centrally placed second contact member. Another advantage of the lamp with a reflector as the outer envelope is that the aperture in the reflector for the light-emitting object may be smaller, which results in a higher light efficacy of the lamp.

In an alternative embodiment of the assembly of a light source and a reflector, the light source including an outer envelope is mounted in the reflector. A greater freedom of designing the reflector is thus provided due to the light source, for instance, a discharge vessel, having its own environmental conditions.

A further advantage of the base according to the invention is that it can easily be adapted to fit a suitable known lamp cap. The lamp cap may be e.g. the conventional E27-E40 cap, or bayonet type socket. The cap can easily be welded to the metal base, e.g. by laser or resistance welding. In an alternative embodiment, the metal base can easily be provided with a profile made to fit an adapted socket.

Another advantage of the lamp according to the invention is the reduction of its length with respect to a lamp with a known cap. This offers the opportunity to introduce electric components into the lamp cap, for example, an ignitor. High-pressure discharge lamps generally need an ignitor to generate a high ignition voltage. This requires a well-insulated current supply between the lamp and the ignitor. The lamp according to the invention therefore has the advantage that the cap can be further provided with an ignitor, thus avoiding the risk of short circuits in a high-voltage current supply outside the lamp.

The invention further relates to a double-ended lamp comprising a light source in an outer envelope, connected on both sides with a lamp base in a gas-tight manner, and is characterized in that the lamp bases are substantially made of a metal. The double-ended lamp according to the invention has the advantage that both lamp bases may serve as contact members, thus avoiding the need for an insulated contact member in one of the bases.

The invention will now be explained in more detail with reference to the drawings, in which:

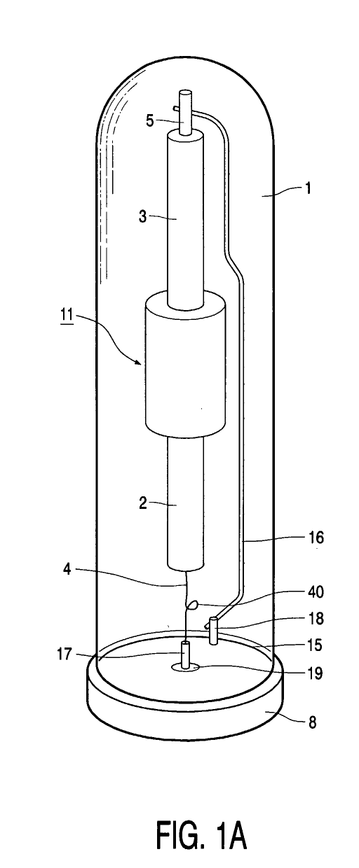

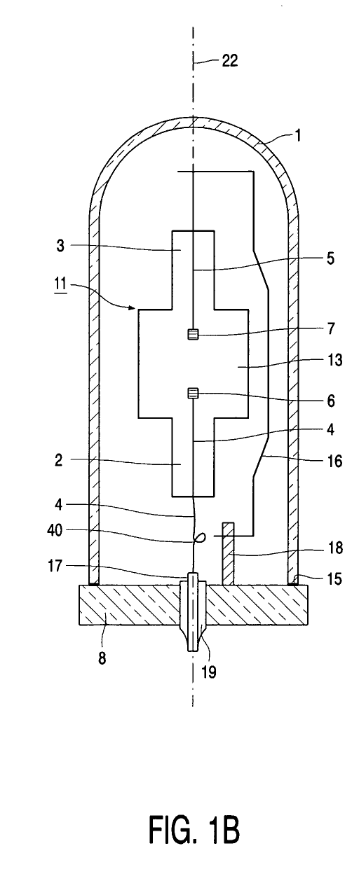

FIG. 1A is an artist's impression of a lamp according to the invention, the lamp being a high-pressure discharge lamp in this Figure.

FIG. 1B is a diagrammatic cross-section of the high-pressure discharge lamp as shown in FIG. 1A.

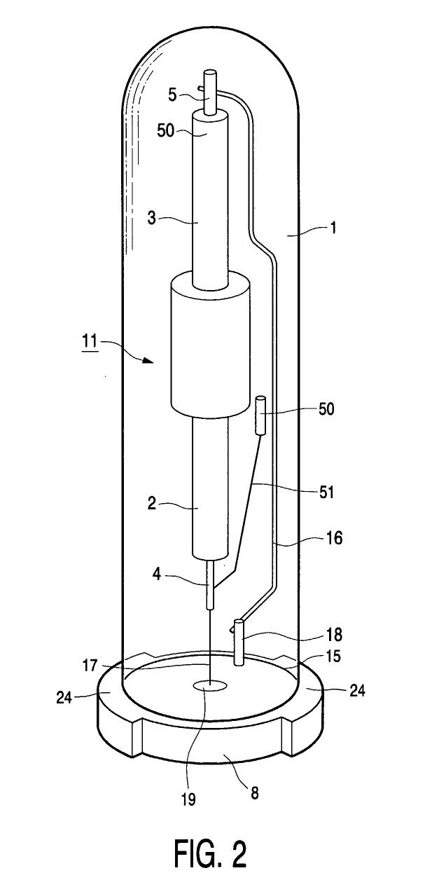

FIG. 2 is an artist's impression of an alternative embodiment of a lamp according to the invention with a UV-enhancer and a base plate provided with a profile.

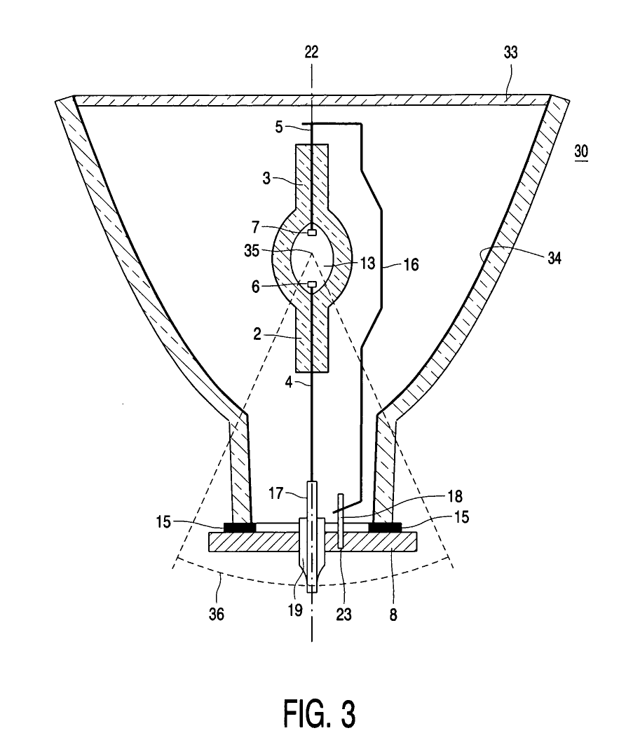

FIG. 3 shows an alternative embodiment of the lamp according to the invention, wherein the outer envelope is a reflector.

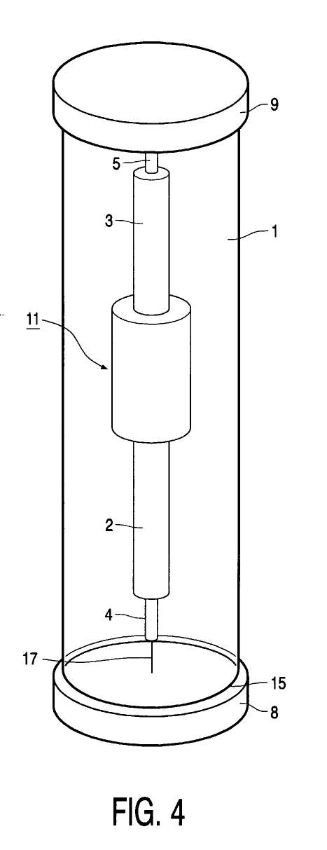

FIG. 4 is an artist's impression of a double-ended version of the lamp according to the invention.

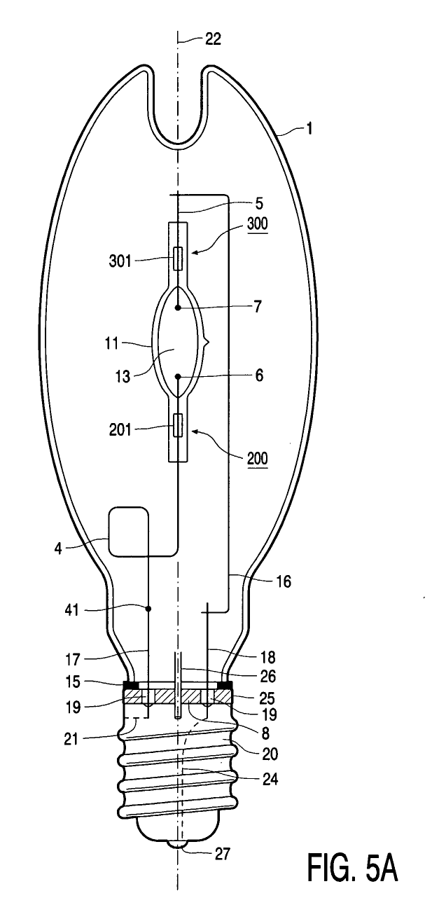

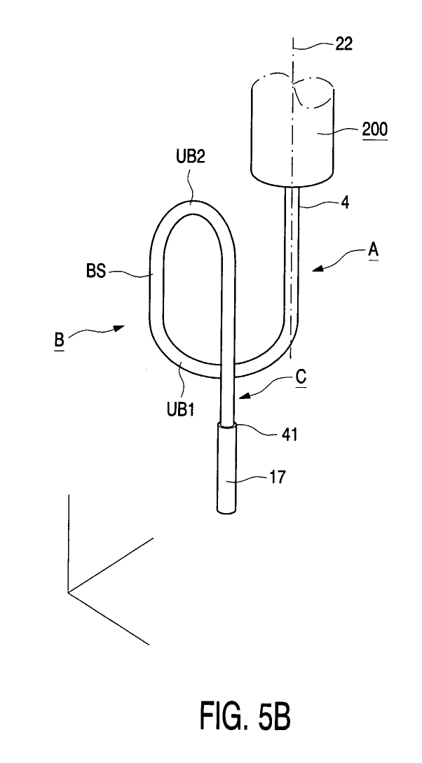

FIG. 5A diagrammatically shows an alternative embodiment comprising a quartz burner and a base which is provided with a cap.

FIG. 5B shows in detail a part of the current supply conductor construction of the lamp of FIG. 5A.

The Figures are purely diagrammatic and not drawn to scale. Some dimensions are strongly exaggerated for reasons of clarity. In the Figures, equivalent components have been denoted as much as possible by the same reference numerals.

The high-pressure discharge lamp of FIG. 1A comprises a discharge vessel 11 as a light source arranged around a longitudinal axis 22. The discharge vessel 11 encloses a discharge space 13 provided with an ionizable filling, for example, a filling comprising mercury, a metal halide, and a rare gas. In the example of FIGS. 1A and 1B, the discharge vessel 11 has a first neck-shaped portion 2 and a second, opposite neck-shaped portion 3, through which portions a first current supply conductor 4 and a second current supply conductor 5, respectively, extend to a pair of electrodes 6, 7 arranged in the discharge space 13. The current supply conductor 4 is provided with a loop 40 to absorb differences in thermal expansion occurring between the discharge vessel, on the one hand, and current conductors, on the other hand. The high-pressure discharge lamp is further provided with a metal lamp base 8. The lamp base 8 supports the discharge vessel 11 by means of a first and a second contact member 17, 18, which are connected to the first and second current supply conductors 4, 5. In the example of FIGS. 1A and 1B, the first contact member 17, placed in the center of the lamp base 8, is insulated from the lamp base by an insulator 19. In addition, the second contact member 18 is connected to the lamp base 8 and to the second current supply conductor 5 via a connection conductor 16 extending alongside the discharge vessel 11. The lamp base 8 also supports an outer envelope 1. The outer envelope is sealed in a gas-tight manner to the metal base by means of an enamel 15. Examples of suitable enamels or frits are frits made by Electroglass (type EG 7578 or EG2000) and frits made by Shott (type G0225 or G01975). The enamel forms a gas-tight connection between the metal base 8 and the outer envelope 1. The connection is formed by heating the enamel ring to a temperature of at most 500° C.

In a practical embodiment, at least one contact member is formed by a feed-through tube in the lamp base, allowing one of the current supply conductors to be fastened in said feed-through tube. Alternatively, two feed-through tubes may be provided in the lamp base. Fastening in these feed-through tubes may be realized by means of resistance welding, laser welding, or crimping. Advantages of the use of a feed-through tube as a contact member are a more robust construction as well as a simpler lamp manufacture, which contributes to achieving a high level of accuracy of positioning the light source in a large-scale industrial manufacturing process.

According to the invention, the outer envelope 1 is connected to the lamp base 8 in a gas-tight manner. The current supply conductors 4, 5 are well protected against oxidation because the atmosphere in the outer envelope is controlled. Preventing oxidation of the current supply conductors 4, 5 has the result that the current supply conductors 4, 5 can be positioned relatively close to the discharge vessel 11.

The contact member 17 is preferably an exhaust tube or an exhaust hole for evacuating the outer envelope 1. In this manner, the outer envelope I can be evacuated via the exhaust tube 17 after the discharge vessel 11 and the outer envelope 1 have been mounted on the lamp base 8 of the high-pressure discharge lamp. After evacuation and, if desired, provision of the desired atmosphere inside the outer envelope, the exhaust tube 17 is sealed. Further advantages of an exhaust tube as a contact member reside in the manufacture of the lamp, both in welding the current supply conductor to the contact member, resulting in a higher level of accuracy of positioning the light source, and in sealing the tube. It is advantageous if the lamp base 8 is made of an NiFeCr alloy like vacovit or Alloy 42.

The lamp base 8 can be manufactured with a high dimensional accuracy. The lamp base 8 has the additional advantage that it can be made reflective or given a light color, for example, white or pale grey. By employing a reflective material or a material with a light color, it is achieved that light emitted by the discharge vessel 11 will be reflected into usable beam angles, thereby increasing the efficiency of the luminaire or the total efficiency of the lamp assembly. It is thereby prevented that the light incident on the lamp base 8 is lost from the light beam which may be formed by means of a reflector. In addition, it is favorable when the lamp base 8 has a (flat) plane at its surface facing away from the discharge vessel 11. This surface may be mounted against a (lamp) holder, for example, a carrier, e.g. a reflector, and is thus a suitable surface serving as a reference for positioning the discharge vessel 11. In a further favorable embodiment, the surface of the lamp base 8 facing the discharge vessel has a central elevation which serves to center the discharge vessel 11 and the enamel ring with respect to the lamp base 8 during manufacture of the lamp.

For lamps according to the invention having a high-pressure discharge vessel as a light source, the outer envelope 1 is preferably made of quartz glass, hard glass or a ceramic material like polycrystalline alumina . For lamps incorporating, for instance, an incandescent filament as a light source, the outer envelope can be alternatively made of soft glass. The outer envelope 1 is preferably fastened to the lamp base 8 by means of an enamel 15. It is favorable when the enamel is provided in the form of a pre-shaped ring. The use of such a pre-shaped ring largely improves the accuracy of positioning the discharge vessel 11 during manufacture of the high-pressure discharge lamp. The choice of the enamel depends on the material of the outer envelope 1 and the material of the lamp base 8.

In practical embodiments of the lamp described in FIGS. 1A and 1B, with nominal powers of 35 W and 75 W, respectively, the lamp is provided with a discharge vessel of the CDM type, made by Philips, generating light having a color temperature of about 3000K with an efficacy of about 90 1 m/W during stable operation. The overall length of the outer envelope and lamp base measured along the longitudinal axis of the lamp is 59 mm. The greatest diameter of the lamp envelope is 10 mm for the 35 W lamp and 14 mm for the 75 W lamp.

FIG. 2 shows an alternative embodiment of the high-pressure discharge lamp according to the invention, provided with a UV-enhancer 50 in the space between the outer envelope and the discharge vessel. A lead-through conductor 51 of the UV-enhancer is connected to the current supply conductor 4 which connects the internal electrode of the discharge vessel to the contact member 17. The UV-enhancer is positioned relative to the connection conductor 16, such that a capacitive coupling is achieved. In the example of FIG. 2, the lamp base is provided with a profile 24 made to fit in an adapted socket. The example of FIG. 3 schematically shows an embodiment of an assembly of a high-pressure discharge vessel as the light source in a reflector 30 arranged around the longitudinal axis 22, together forming a lamp according to the invention. The reflector 30 comprises a reflecting surface 34 on a (glass) support. The reflector 30 is provided with a transparent cover plate 33. The cover plate can be shaped as a lens. In the example of FIG. 3, the reflector 30 forms the outer envelope which is supported by the lamp base 8, for instance, by a (glass) frit enamel 15. The second contact member 18 is an exhaust tube for evacuating the interior of the reflector 30 comprising the high-pressure discharge vessel provided in the lamp base 8. In this manner, the reflector 30 can be evacuated via the exhaust tube 18 after the discharge vessel 11 provided on the lamp base 8 has been mounted in the reflector 30. After evacuation of the assembly of high-pressure discharge vessel and reflector 30 and, if desired, provision of the desired atmosphere inside the reflector 30, the exhaust tube 18 is sealed. Consequently, the opening of the reflector sealed by the lamp base can be given a reduced diameter. A more effective reflector design is thus achievable. In an alternative embodiment of the assembly of a high-pressure discharge vessel and a reflector, the discharge vessel is provided with a separate outer envelope before being mounted in the reflector. The fact that the discharge vessel has its own environmental conditions provides greater freedom of designing the reflector.

FIG. 3 shows that the lamp base 8 falls substantially entirely within a cone 36 which has its apex 35 in the center of the discharge vessel 11. The apex angle is preferably kept as small as possible, for instance, 25°. The light originating from the high-pressure discharge vessel can reach the reflecting surface 34 substantially without obstruction and is reflected there at least substantially axially in the direction of the transparent cover plate 33. In an alternative embodiment, the cover plate is dome-shaped.

Since the lamp according to the invention can be given a very small constructional height, reflectors in which the discharge lamp is accommodated may be comparatively flat. The discharge vessel of a 20 W high-pressure discharge lamp may have, for example, a dimension along the longitudinal axis 22 of 42 mm from the outside of the lamp base 8 to the top of the cover plate 33. If the length of the neck-shaped portions 2, 3 is reduced or the neck-shaped portions are absent, the dimension along the longitudinal axis 22 may be considerably smaller. In the assembly shown in FIG. 3, the high-pressure discharge vessel including supply conductors and connection conductor forms a “building block” of the assembly. The positioning accuracy of the discharge vessel with respect to the base plate may be extremely high and is typically better than 0.15 mm. The very high dimensional reproducibility of the base plate 8 allows its use in assemblies with different connections.

FIG. 4 is an artist's impression of a double-ended lamp having an elongated outer envelope, closed at both ends with a lamp base wherein both lamp bases 8 and 9 serve as a contact member. The outer envelope of this lamp is preferably a ceramic envelope.

A practical embodiment of the lamp of FIG. 4 has a nominal power of 250 W and a total length of 130 mm and an outer diameter of 16 mm.

FIG. 5A shows a lamp according to the invention with a discharge vessel 11 made of quartz glass enclosing the discharge space 13 provided with an ionizable filling. The discharge vessel is provided with first and second mutually opposite collapsed seals 200, 300, each comprising knife-edged foils 201, 301, respectively. The foils connect electrodes 6, 7 to first and second current supply conductors 4, 5, respectively. The metal lamp base 8 supports the discharge vessel via the first current supply conductor 4 having a weld 41 with the first contact member 17 and the second current supply conductor 5, electrically connected with the second contact member 18. Contact members 17, 18 and current supply conductors 4, 5 form respective first and second current paths to the pair of electrodes.

The lamp base 8 also supports the outer envelope 1.

The lamp base 8 is further provided with a conventional cap 20 connected to the base by means of a weld 25. The connection members 17 and 18 are electrically connected with the cap 20 and a connection point 27 by means of conductors 21 and 24, respectively.

FIG. 5B shows a part of the first current supply conductor 4 in detail. The first current supply conductor has a first section A extending from the first current supply conductor 4 along the longitudinal axis 22 towards the first connection member 17 in the lamp base, a second section B bent away and extending effectively transversely to the longitudinal axis, and a third section C extending towards the first contact member 17.

The second section B comprises two U-bends UB1, UB2 separated by an intermediate straight part BS, each U-bend lying in a mutual different plane. In the configuration shown, U-bend UB1 is in a plane through the longitudinal axis 22 and U-bend UB2 is in a plane substantially transverse to the plane in which U-bend UB1 is located.

In the embodiment shown, sections A, B and C are formed by the first current supply conductor 4. The third section C is welded to the first contact member 17 at the butt weld 41. The loop thus formed by sections A, B, and C has a length of 4 mm along the axis 22 and a width of 3 mm squarely thereto.

A suitable material for use as a current supply conductor is Nb. It closely matches the thermal expansion rate of ceramic materials and has a high degree of ductility, which has the advantage that the necessary bending is easy and that a large absorbing capacity is achieved for absorbing differences in thermal expansion between the current supply conductor and the discharge tube.

A practical embodiment of the lamp shown in the drawing has a nominal power of 100 W.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer. In the device claim enumerating several means, several of these means may be embodied by one and the same item of hardware. The mere fact that certain measures are recited in mutually different dependent claims does not indicate that a combination of these measures cannot be used to advantage.

1. A lamp comprising a light source in an outer envelope which is connected to a lamp base in a gas-tight manner, characterized in that the lamp base is substantially made of a metal.

2. A lamp as claimed in claim 1, wherein a connection between the outer envelope and the base is provided by an enamel.

3. A lamp as claimed in claim 1, wherein the lamp base constitutes a first contact member.

4. A lamp as claimed in claim 1, wherein the lamp base is provided with a second contact member insulated from the lamp base.

5. A lamp as claimed in claim 1, wherein one contact member is at the center of the lamp base.

6. A lamp as claimed in claim 1, wherein an exhaust tube or an exhaust hole for evacuating the outer envelope is provided in the lamp base.

7. A lamp as claimed in claim 1, wherein a contact member is used as an exhaust tube.

8. A lamp as claimed in claim 1, further comprising a getter, wherein the getter is placed between the light source and the base.

9. A lamp as claimed in claim 1, wherein the lamp base is provided with a profile made to fit in an adapted socket.

10. A lamp as claimed in claim 1, wherein the outer envelope constitutes a reflector.

11. A lamp as claimed in claim 1, wherein the base is provided with a cap.

12. A lamp as claimed in claim 11, wherein the cap is provided with an ignitor.

13. A double-ended lamp comprising a light source in an elongated outer envelope, closed at both ends with a lamp base in a gas-tight manner, characterized in that the lamp bases are substantially made of a metal.
